(19) United States
(12) Patent Application Publication
(10) Pub. No.: US 2015/0116736 A1
(43) Pub. Date: Apr. 30, 2015

(54) PRINTER WITH FEEDBACK CORRECTION OF IMAGE PLANE ALIGNMENT

(71) Applicants: Joshua Hart Howard, Kettering, OH (US); Matthias Hermann Regelsberger, Rochester, NY (US); Kevin Edward Spaulding, Spencerport, NY (US)

(72) Inventors: Joshua Hart Howard, Kettering, OH (US); Matthias Hermann Regelsberger, Rochester, NY (US); Kevin Edward Spaulding, Spencerport, NY (US)

(21) Appl. No.: 14/061,873

(22) Filed: Oct. 24, 2013

(51) Int. Cl. G06K 15/02; G06K 9/62; G06K 9/20

(52) U.S. Cl. CPC G06K 15/027; G06K 15/1872; G06K 9/20; G06K 9/6201
USPC 358/1.4

(57) ABSTRACT

A printer includes first and second marking units for printing respective first and second image planes on a receiver medium. A digital image capture system is positioned downstream of the second marking unit, and is used to capture an image of printed first and second image plane. Image data for the first and second image planes is compared to the captured image of the respective image planes to determine respective first and second displacements between the nominal locations and the actual locations of the printed image data. Corresponding spatial adjustments are applied to image data for at least one image plane of a subsequent image to provide reduced alignment errors between the printed image data for the first and second image planes in the subsequent image.

### CROSS-REFERENCE TO RELATED APPLICATIONS

Reference is made to commonly assigned, co-pending U.S. patent application Ser. No. ______ (Docket K001275), entitled: “Printer with image plane alignment correction”, by Howard et al.; and to commonly assigned, co-pending U.S. patent application Ser. No. ______ (Docket K001641), entitled: “Printer with feedback correction of image displacements”, by Howard et al., each of which is incorporated herein by reference.

### FIELD OF THE INVENTION

This invention generally relates to a digital printing system, and more particularly to the correction of image plane displacement errors based on image comparisons made between the image data and a captured image of the printed output.

### BACKGROUND OF THE INVENTION

In multi-channel digital printing systems, images for a plurality of image channels are printed in alignment onto a receiver medium. In many such digital printing systems, a plurality of printing modules (e.g., inkjet printheads or electrophotographic print engines) are provided, one for each channel, and multi-channel images are printed by moving a receiver medium past each of the printing modules where the channels are printed in sequence. Typically, the different channels (i.e., “image planes”) are used to print different colorants (e.g., cyan, magenta, yellow and black). In some embodiments, a plurality of channels may be used to print a single colorant, or light and dark variations of the same colorant. For example a black colorant can be printed using two different printer channels to increase the density of the printed image. In some embodiments, a first set of channels can be used to print on one side of the receiver medium, and a second set of channels can be used to the print on the opposite side of the receiver medium (using the same or different colorants).

The printed item produced by the digital printing systems need not be restricted to an image printed on the receiver medium for viewing by an observer, but can also include items printed for a functional purpose such as printed circuitry. In this example, the different channels can correspond to different layers in a multi-layer circuit.

In some applications, the receiver medium may undergo changes between the printing of one channel and another. For example, when a multi-color image is printed by depositing ink on a paper-based receiver medium, the water in the ink printed for one channel can cause the receiver medium to expand before a subsequent channel is printed. The receiver medium could also undergo other processing steps between the printing of the image planes that could change the dimensions of the receiver medium. For example, the receiver medium could pass through a dryer (in case of printing with liquid inks) or a fusing step (in case of dry powder electrophotography) between the printing of the various channels, which can cause the receiver medium to shrink before the printing of a subsequent channel. The desired registration of one channel to another can be adversely affected by the dimensional changes of the receiver medium between the printing of the multiple channels. In many cases, the dimensional changes in the receiver medium may be a function of a variety of factors such as image content of the printed image, the drying steps along the printing process and environmental conditions.

In another example, a non-conductive layer can be applied over conductive traces for a layer of circuitry printed on a receiver medium before the printing of a subsequent image plane for another layer of circuitry, where the application of the non-conductive layer produces dimensional changes in the receiver medium (and the already printed image plane). In such systems, the desired registration of one image plane to another can be adversely affected by the dimensional changes of the receiver medium between the printing of the multiple layers.

In some cases, the printing modules used for printing the different channels may have some variation between them, so that there is a dimensional scaling or magnification change between the channels printed by the different printing modules.

In other applications, it may be necessary to adjust the dimensions of a document printed by a digital printing system even if it contains only a single channel. Such an adjustment may be necessary to match the dimensions of the printed document with the dimensions required by a downstream process. For example it may be necessary to adjust the print width of the printed document so that it correlates with the width of a downstream slitting, perforating, or folding operation.

A number of methods for using image capture devices to monitor the image quality of printed output have been described in prior art. Examples of such applications include vision capture systems that capture the printed output from printing systems such as offset printing devices and display the captured output to the operator to take recommended or necessary corrective actions.

U.S. Pat. No. 7,423,280 to Pearson et al., entitled “Web inspection module including contact image sensors,” discloses an image capture device having a light source, a contact image sensor and a gradient index lens array to image the printed output onto a sensor array. The image of the printed output is displayed for the operator together with color aim values for selected parts of the image and recommended correction values for the individual color separations. Also displayed are registration targets with suggested values for their corrections. The operator is expected to apply these corrections to the printing process and to observe their impact on the prints following this manual adjustment.

U.S. Patent Application Publication 2010/0123780 to Wiebe, entitled “Method and device for monitoring a printed image on a moving material web,” describes the display of a captured image of a printed output, together with a selected reference image. This enables an operator to monitor and assess the quality of the printing process by visual comparison on the display.

U.S. Pat. No. 8,197,022 to Saettel, entitled “Automated time of flight speed compensation,” discloses a printing system having multiple inkjet print modules. Each of the print modules is followed in the process direction by an image capture system. The image capture system evaluates the position of printed registration marks and determines a correction value for the associated print module to bring it into register with the first image plane. The correction value is used to advance or delay the ink drop generation such that the resulting registration mark on the receiver is in register with the registration mark of the first image plane.

U.S. Pat. No. 7,536,955 to Bernard et al., entitled “Method and device for influencing the fan-out effect,” teaches the use of a camera system in an offset printing press to determine the lateral distortion of the receiver web between print stations with respect to printed reference marks applied by the upstream print station. The measurement is converted to a control signal increasing or decreasing the output of a fan deflecting the web by impinging air to compensate for the lateral distortion of the web.

U.S. Pat. No. 7,650,019 to Türke et al., entitled “Method for the early identification of a deviation in the printed images that have been created by a printing press during continuous production,” describes an image quality control system that compares the color of a captured output image with the corresponding aim color of a reference image. Color comparisons are based on averages within a small image area (e.g., 8×8 pixels), and deviations from the aim color are averaged over a few successive prints. Detected deviations from the aim color are displayed for the operator to take corrective actions. Various modes of averaging are described to display a trend in color errors so that the operator is enabled to take corrective action before the color error is too large and the print production yields unacceptable poor print quality.

U.S. Pat. No. 6,068,362 to Dunand et al., entitled “Continuous multicolor ink jet press and synchronization process for this press,” discloses a printing system in which marks are evenly spaced along the web of paper in the in-track direction for the purpose of in-track registration control. The line-by-line output of the digital writing system is adjusted to make the in-track dimensions of all print planes identical.

U.S. Pat. No. 4,721,969 to Asano, entitled “Process of correcting for color misregistration in electrostatic color recording apparatus”, discloses a printing system employing marks on both side of the image to determine the displacement errors of the image during the printing process. An inferred shrinkage or elongation of the paper in the cross-track and in-track directions is assumed to be uniform. Magnification corrections in the cross-track direction are accomplished by omitting pixels or inserting dummy pixels for each line, whereas magnification corrections in in-track direction are applied by removing entire printed lines or modifying the transport speed.

The prior art methods typically evaluate displacement errors based on monitoring printed registration marks. In general, such printed registration marks are not desirable within the printed image, or anywhere within the finished product; therefore, they can only be placed outside the printed image in a portion of the receiver medium to be trimmed off in a finishing operation. The need for the trimming operations represents an extra step in the finishing operation, which has the disadvantage of wasting materials and adding cost. There remains a need for improved methods to correct for image plane displacement errors in a multi-channel printing system that does not rely on printed registration marks.

### SUMMARY OF THE INVENTION

The present invention represents a printer for printing an image on a receiver medium moving along a transport path, comprising:

a first marking unit for printing image data for a first image plane by depositing a first marking material on the receiver medium as the receiver medium is transported along the transport path past the first marking unit;

a second marking unit for printing image data for a second image plane by depositing a second marking material on the receiver medium as the receiver medium is transported along the transport path past the second marking unit, the second marking unit being positioned along the transport path downstream of the first marking unit;

a digital image capture system positioned along the transport path downstream of the second marking unit, the digital image capture system being adapted to capture an image of the printed first and second image planes; and

a control system that implements an image alignment method, wherein the image alignment method includes:
receiving image data for the first and second image planes;
controlling the first marking unit to print the image data for the first image plane by depositing a corresponding pattern of the first marking material on the receiver medium;
controlling the second marking unit to print the image data for the second image plane by depositing a corresponding pattern of the second marking material on the receiver medium;
controlling the digital image capture system to capture an image of the printed first and second image planes;
comparing the image data for the first image plane to the captured image of the printed first image plane to determine a first displacement between a nominal location of the printed image data for the first image plane and an actual location of the printed image data for the first image plane;
comparing the image data for the second image plane to the captured image of the printed second image plane to determine a second displacement between a nominal location of the printed image data for the second image plane and an actual location of the printed image data for the second image plane; and
determining spatial adjustments in accordance with the determined first and second displacements; and
applying the spatial adjustments to image data for at least one of the first and second image planes of a subsequent image in accordance with the determined first and second displacements;

wherein the spatial adjustment of the image data for the at least one of the first and second image planes of the subsequent image is adapted to provide reduced alignment errors between the printed image data for the first and second image planes in the subsequent image.

This invention has the advantage that the image alignment method does not require the use of specialized registration marks that must be located outside of the printed image region, and must be trimmed from the final printed product.

It has the additional advantage that the image planes in the printed image can be adjusted in real time to correct for distortions in the receiver medium.

It has the further advantage that the image displacement and the corresponding spatial adjustments can vary as a function of location within the printed image to compensate for non-uniform distortions of the receiver medium.

### BRIEF DESCRIPTION OF THE DRAWINGS

FIG. 1 is a diagram illustrating a digital printing system having a plurality of printing modules and digital image capture systems;

FIG. 2 is a flow chart of an image alignment method for aligning first and second image planes;

FIG. 3 is a diagram illustrating a digital printing system having a plurality of printing modules and digital image capture systems, as well as a registration sensor;

FIG. 4 is a flow chart of an image alignment method for aligning a first image plane with registration features;

FIG. 5 is a flow chart of an image alignment method for aligning an image plane using a feedback process;

FIG. 6 is a diagram illustrating a digital printing system having a registration sensor, and digital image capture systems positioned downstream of a plurality of printing modules; and

FIG. 7 is a flow chart of an image alignment method for aligning first and second image planes using a feedback process.

It is to be understood that the attached drawings are for purposes of illustrating the concepts of the invention and may not be to scale. Identical reference numerals have been used, where possible, to designate identical features that are common to the figures.

### DETAILED DESCRIPTION OF THE INVENTION

The present description will be directed in particular to elements forming part of, or cooperating more directly with, apparatus in accordance with the present invention. It is to be understood that elements not specifically shown or described may take various forms well known to those skilled in the art.

In the following description, some aspects of the present invention will be described in terms that would ordinarily be implemented as software programs. Those skilled in the art will readily recognize that the equivalent of such software may also be constructed in hardware. Because image processing algorithms and systems are well known, the present description will be directed in particular to algorithms and systems forming part of, or cooperating more directly with, the method in accordance with the present invention. Other aspects of such algorithms and systems, together with hardware and software for producing and otherwise processing the image signals involved therewith, not specifically shown or described herein may be selected from such systems, algorithms, components, and elements known in the art. Given the system as described according to the invention in the following, software not specifically shown, suggested, or described herein that is useful for implementation of the invention is conventional and within the ordinary skill in such arts.

A computer program product can include one or more non-transitory, tangible, computer readable storage medium, for example; magnetic storage media such as magnetic disk (such as a floppy disk) or magnetic tape; optical storage media such as optical disk, optical tape, or machine readable bar code; solid-state electronic storage devices such as random access memory (RAM), or read-only memory (ROM); or any other physical device or media employed to store a computer program having instructions for controlling one or more computers to practice the method according to the present invention.

The invention is inclusive of combinations of the embodiments described herein. References to “a particular embodiment” and the like refer to features that are present in at least one embodiment of the invention. Separate references to “an embodiment” or “particular embodiments” or the like do not necessarily refer to the same embodiment or embodiments; however, such embodiments are not mutually exclusive, unless so indicated or as are readily apparent to one of skill in the art. The use of singular or plural in referring to the “method” or “methods” and the like is not limiting. It should be noted that, unless otherwise explicitly noted or required by context, the word “or” is used in this disclosure in a non-exclusive sense.

The present invention is well-suited for use in roll-fed inkjet printing systems that apply colorant (e.g., ink) to a web of continuously moving receiver medium (also known in the art as “print media”). In such systems a printhead selectively moistens at least some portion of the receiver medium as it moves through the printing system, but without the need to make contact with the receiver medium. While the present invention will be described within the context of a roll-fed inkjet printing system, it will be obvious to one skilled in the art that it can also be used for other types of printing systems such as sheet-fed printing systems and electrophotographic printing systems.

Although the present invention is applicable to any type of printing system that requires accurate image plane registration, it is of increasing value for printing systems where the receiver medium experiences significant dimensional changes during the printing process (e.g., due to expansion of the medium due to the absorption of ink). For example, significant deformations can occur if the web tension varies significantly as it moves from one printhead to another (particularly for thin media), if the time between the printing of the image planes is relatively large, or if the printed receiver medium undergoes some process or treatment, (e.g., drying, curing or fusing), between the printing of the image planes.

In the context of the present invention, the terms “web media” or “web of media” are interchangeable and relate to a receiver medium that is in the form of a continuous strip of media that passes through a web media transport system from an entrance to an exit thereof. The continuous web media serves as the receiver medium to which one or more colorants (e.g., inks or toners), or other coating liquids are applied. This is distinguished from various types of “continuous webs” or “belts” that are actually transport system components (as compared to the print receiving media) which are typically used to transport a cut sheet receiver medium in an electrophotographic or other printing system. The terms “upstream” and “downstream” are terms of art referring to relative positions along the transport path of a moving web; points on the web move from upstream to downstream.

Additionally, as described herein, the example embodiments of the present invention provide a printing system or printing system components typically used in inkjet printing systems. However, many other applications are emerging which use inkjet printheads to emit liquids (other than inks) that need to be finely metered and deposited with high spatial precision. As such, as described herein, the terms “liquid,” “ink,” “print,” and “printing” refer to any material that can be ejected by the liquid ejector, the liquid ejection system, or the liquid ejection system components described below.

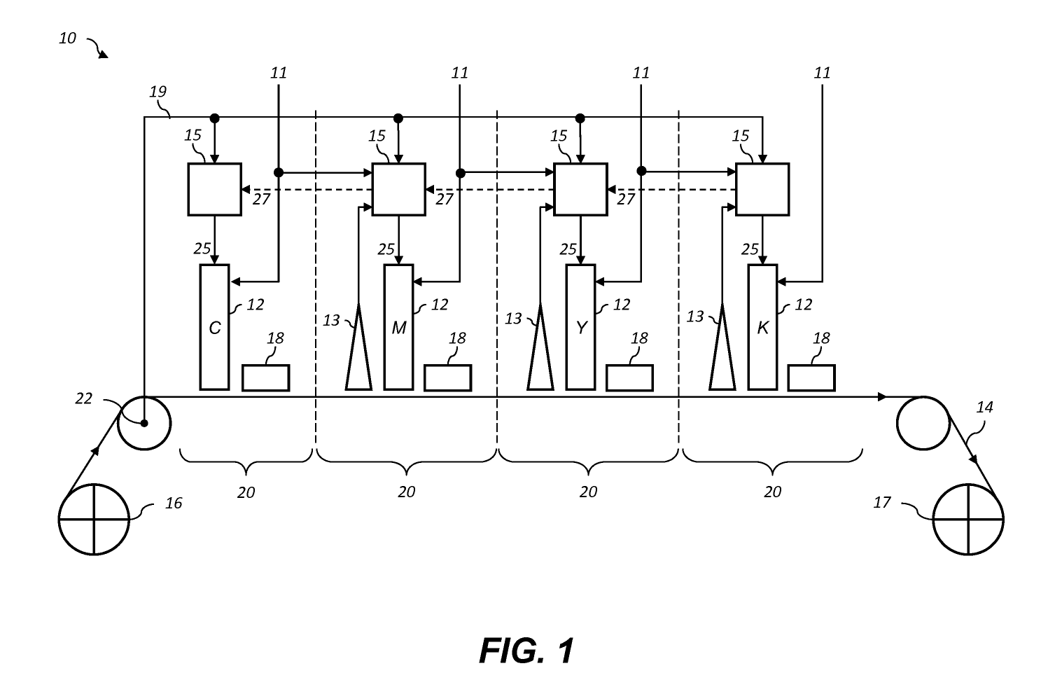

FIG. 1 shows a diagram illustrating a multi-channel digital printing system 10 for printing on a web of receiver medium 14, which travels along a transport path from a supply roll 16 to a take-up roll 17. The receiver medium 14 can be any medium appropriate for receiving the marking materials printed by the printing system 10. For example, the receiver medium 14 can be a paper, a plastic (e.g., clear film), or a textile.

The printing system 10 includes a plurality of printing modules 20 (sometimes referred to as marking units). The printing modules 20 are adapted to deposit a corresponding marking material onto the receiver medium 14 in accordance with image data 11 (sometimes called “print data”) received from a digital front end (not shown). The image data 11 is generally represented as an array of pixel values corresponding to an array of pixel position, where the pixel values specify a colorant amount to be printed at the corresponding pixel location. In a preferred embodiment, the printing modules 20 are inkjet printing modules having printheads 12 (also known as marking units) adapted to print drops of ink onto the receiver medium 14 through an array of inkjet nozzles in accordance with image data 11. In other embodiments, the printing modules 20 can be electrophotographic printing modules that produce images by applying solid or liquid toner to the receiver medium 14. Alternately, the printing modules 20 can utilize any type of digital printing technology known in the art.

In a preferred embodiment, the printing system 10 is adapted to print a multi-color image that is intended to be viewed by an observer. In this case, the marking materials are colorants such as inks or toners. In other embodiments, the printing system 10 can be used to produce items printed for a functional purpose such as printed circuitry. In this example, the marking materials can correspond to the materials needed for the layers in a multi-layer circuit.

In the illustrated embodiment, four printing modules 20 are shown which print cyan (C), magenta (M), yellow (Y) and black (K) marking materials (e.g., inks or toners) onto the receiver medium 14 as it passes through the printing system along the transport path from an upstream position to a downstream position as defined by motion of the receiver medium 14. In other embodiments, the printing modules 20 can be adapted to print different numbers and types of marking materials. For example, additional printing modules 20 can be used to print specialty colorants, or extended gamut colorants. In some embodiments, a plurality of the printing modules 20 can be used to print the same marking materials (e.g., black ink), or density variations of the same color (e.g., gray and black inks). In some embodiments, the printing system 10 is adapted to print double-sided pages. In this case, one or more of the printing modules 20 can be arranged to print on a back side of the receiver medium 14. In some embodiments, the marking materials can also include other types of materials such as clear materials (e.g., for providing protective layers, gloss control layers or texture-forming layers), solvent materials, or functional materials (e.g., electrical conducting or insulating materials).

The exemplary printing system 10 also includes a dryer 18 with every printing module 20 for drying the ink applied by the printhead 12 to the receiver medium 14. While the exemplary embodiment illustrates a dryer 18 following each of the printheads 12, this is not a requirement. In some embodiments, a single dryer 18 may be used following the last printhead 12, or dryers 18 may only be provided following some subset of the printheads 12. Depending on the printing technology used in the printing modules 20, and the printing speed, it may not be necessary to use any dryers 18.

Each printing module includes a controller 15, which is a data processor adapted to control the associated printing module 20. All of the controllers 15, together with other data processors that may be associated with the printing system 10, make up the control system for the printing system 10. Typically, the printing system 10 is designed to print lines of image at a specified resolution (e.g., 600 lines per inch (lpi)). An encoder 22 located along the transport path before the first printing module 20 generates a master timing signal 19 (e.g., 600 pulses per inch) that is tied to the motion of the receiver medium 14. This master timing signal 19 is provided to the controller 15 in each printing module 20 to trigger the line-by line output of the printhead 12. The encoder 22 can generate the master timing signal 19 using any of the various contact or non-contact detection means that are known in the art, either by sensing the motion of the receiver medium 14, or a component such as a roller that moves with the receiver medium 14.

In accordance with the present invention, the printing system 10 includes at least one image capture system 13. In the embodiment shown in FIG. 1 an image capture system 13 is part of every printing module 20 except the first one, the image capture devices in the second through fourth modules being located upstream of the respective printheads 12. The image capture systems 13 are adapted to capture an image of a portion of the receiver medium 14 that includes printed image data deposited by upstream printheads 12. The image capture systems 13 can utilize any image capture images using any imaging technology known in the art. In some embodiments, some or all of the image capture systems 13 can be digital camera systems that utilize image sensors with two-dimensional (2D) arrays of sensor pixels. Alternatively, some or all of the image capture systems 13 can be line scanning systems that utilize image sensors with linear one-dimensional (1D) arrays of sensor pixels. Line scanning systems capture images of the receiver medium 14 one line at a time as the receiver medium 14 moves past the 1D line sensor.

Each image capture system 13 is connected to the controller 15, which is adapted to accept and analyze the captured image data to determine appropriate control signals. In accordance with the present invention, the controller 15 compares the image data 11 for one or more of the previously printed image planes with the captured image data from the image capture system 13 to determine a displacement between a nominal location of the printed image data and an actual location of the printed image data. The displacement is then used to determine appropriate spatial adjustment control signals 25 which specify spatial adjustments that can be applied to the image data 11 to reduce alignment errors between the printed image data for the previous image plane(s) and the printed image data for the current image plane. The spatial adjustments may include parameters specifying spatial shifts or resize factors to be applied in one or both of the cross-track and in-track dimensions. In the illustrated embodiment, the spatial adjustment control signals 25 are passed to the corresponding printhead 12, which includes a data processor which is adapted to apply the spatial adjustment control signals 25 to the image data 11 and then print the adjusted image data. In other embodiments, the spatial adjustment control signals 25 can be applied to the image data 11 in the controller 15, or in some other data processor, rather than in the printhead 12.

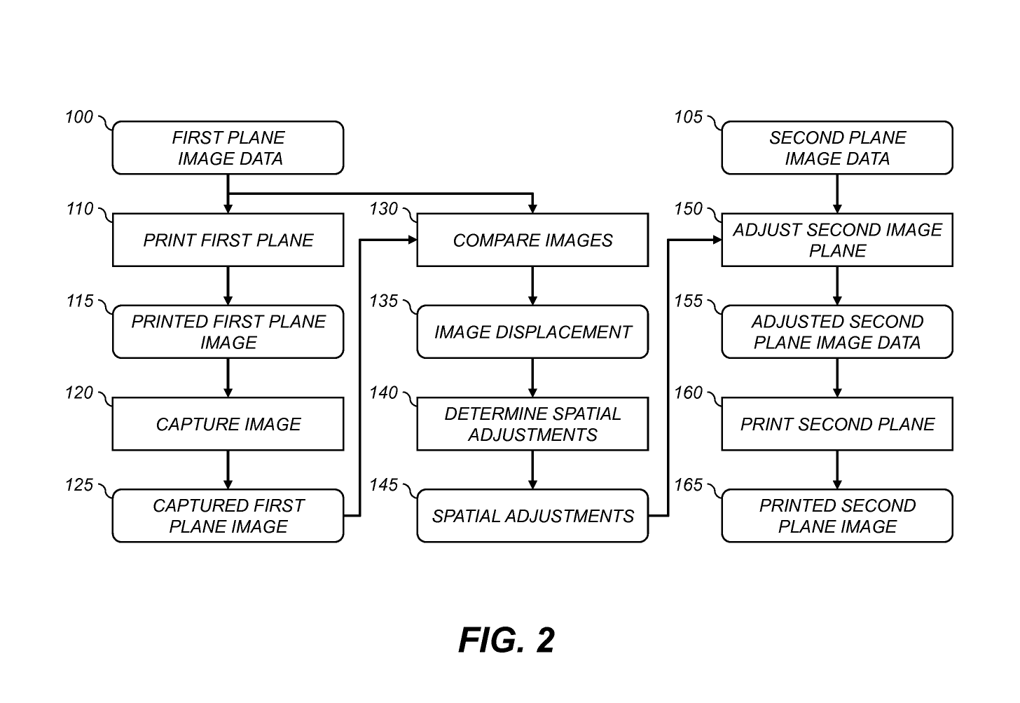

FIG. 2 shows a flowchart of a method for producing a printed image with reduced alignment errors in accordance with an embodiment of the present invention. The inputs to the process are first plane image data 100 and second plane image data 105 for printing using respective first and second printing modules 20 (FIG. 1). The first plane image data 100 will generally include a bitmap of the image to be printed by the first printing module 20, as well as any associated layout information needed to specify the intended location that the bitmap should be printed on the receiver medium 14. Similarly, the second plane image data 105 will generally include a bitmap of the image to be printed by the second printing module 20, as well as any associated layout information needed to specify the intended location that the bitmap should be printed on the receiver medium 14. A print first plane step 110 is used to print the first plane image data 100 using the first printing module 20 by depositing an associated marking material on the receiver medium 14 (FIG. 1), thereby producing a printed first plane image 115.

A capture image step 120 is used to capture an image of the printed first plane image 115 using the image capture system 13 (FIG. 1) positioned after the printhead 12 (FIG. 1) in the first printing module 20, thereby providing a captured first plane image 125. It is generally necessary to have an accurate mapping of the image pixels in the captured first plane image 125 to the corresponding physical locations on the printed first plane image 115. This mapping can be determined using a calibration process where an image of a target with known geometry (e.g., a grid of lines with known pixel positions) is captured using the image capture system 13 (FIG. 1). In a preferred embodiment, the captured first plane image 125 is resampled to remove any geometric distortions introduced by the image capture system 13, and to compensate for any resolution difference between the captured first plane image 125 and the first plane image data 100. It is also necessary to know the position of the image capture system 13 in both the cross-track and in-track directions with respect to the printheads 12 in order to know when the printed first plane image 115 will be passing by the image capture system 13. The cross-track and in-track positions of the various components (e.g., the printheads 12 and the image capture systems 13, as well as elements of the web transport system) are generally determined during a calibration process that is performed as part of the device manufacturing process, as well as after service events that affect the position of the relevant components. The cross-track and in-track positions measured during such calibration processes are stored in computer memory and retrieved as fixed corrections to the components of the image displacements vectors calculated according to this disclosure as described below

The captured first plane image 125 provides a representation of the geometry of the printed image, which should nominally match the first plane image data 100. However, due to various reasons such as expansion or shrinkage of the receiver medium 14 (FIG. 1) during the printing/drying process, the actual geometry of the printed first plane image 115 may be distorted such that the image content is displaced relative to its intended position. Other sources of distortions would include skew or lateral drift of the web of receiver medium 14 as it travels through the printing system 10 (FIG. 1).

The distortions in the geometry of the printed first plane image 115 can be characterized by using a compare images step 130 to compare the captured first plane image 125 with the first plane image data 100. The compare images step 130 determines an image displacement 135 which provides an indication of the geometric distortions introduced into the printed first plane image 115 (i.e., the differences between a nominal location of the printed image data as specified by the first plane image data 100 and an actual location of the printed image data as characterized by the captured first plane image 125). In some embodiments, the entire first plane image data 100 is compared to the entire captured first plane image 125 to determine the image displacement 135 in a single operation. In other cases, a subset of the first plane image data 100 (e.g., a single line, or a set of lines) is compared to a corresponding subset of the captured first plane image 125. For example, if the capture image step 120 uses a 1D line scanning system, the lines of the captured first plane image 125 can be compared to the first plane image data 100 on a line-by-line basis in real time as they are captured. For cases where the distance between the image capture system 13 and the printhead 12 is smaller than the size of the printed image, it is not possible to capture the entire captured first plane image 125 before it is necessary to apply the adjustments to the first part of the second plane image data 105. As a result, it is necessary to determine the image displacement 135 in real-time for a subset of the first plane image data 100, while the rest of the captured first plane image 125 is still being captured.

It should be noted that the printed first plane image 115 corresponds to the image content (e.g., text, graphics or photographic images) being printed for the printed product being produced by the printing system 10. The printed first plane image 115 should be distinguished from special-purpose registration marks that are sometimes formed along the edge of the receiver medium 14 during some printing processes for the specific purpose of detecting registration information. The present invention has the advantage that by using the actual image content of the printed first plane image 115 in the determination of the image displacement 135, it is possible to accurately align the image planes without needing to print registration features. Prior art systems that utilize registration marks to align the image planes typically trim off the portions of the receiver medium 14 having the printed registration marks, which adds cost and creates waste. The present invention has the additional advantage that using the actual image content of the printed first plane image 115 enables the image displacement 135 to be determined as a function of location within the printed image. For prior art systems that rely on registration marks, the image displacement can only be evaluated along the edges of the receiver medium 14 since it would not be desirable to include registration marks within the printed image content. As a result, the registration marks are not able to provide any information about local distortions of the receiver medium 14.

In some cases, the printed first plane image 115 will simply be shifted relative to the first plane image data 100. In this case, the image displacement 135 will be constant for all locations within the printed first plane image 115. More generally, the image displacement 135 will vary as a function of location within the printed first plane image 115. For example, if the receiver medium 14 expands as it absorbs the ink deposited in the print first plane step 110, image content on the left side of the receiver medium 14 can be displaced to the left, while image content on the right side of the receiver medium 14 can be displaced to the right. Typically, the image displacement 135 will be a function of the amount and distribution of marking material (e.g., ink) deposited during the print first plane step 110. For example, if the printed first plane image 115 includes a region of high ink lay-down (e.g., a photographic image), and another region of low ink lay-down, the receiver medium 14 may expand more in the region of high ink lay-down.

In various embodiments, the image displacement 135 can represent the displacement in the printed image data in a variety of different manners. For example, the image displacement 135 can be a set of parameters that characterize the geometric distortion of the printed first plane image 115. In some embodiments, the parameters can include some or all of a cross-track displacement parameter, an in-track displacement parameter, a cross-track magnification factor parameter, an in-track magnification factor parameter, and a skew angle parameter.

In other embodiments, the image displacement 135 can be represented using a parametric image displacement function with an appropriate functional form. For example, the image displacement 135 can be represented using cross-track and in-track displacement functions of the form:

Δx=fₓ(x,y)

Δy=f_{y}(x,y) (1)

where fₓ(x,y) is the cross-track displacement function, f_{y}(x,y) is the in-track displacement function, x and y are cross-track and in-track coordinates within the first plane image data 100, respectively, and Δx and Δy are the cross-track and in-track displacements, respectively.

In some embodiments, the cross-track and in-track displacement functions can be represented using parametric functions such as:

fₓ(x,y)=A₀+Aₓx+A_{y}y+Aₓₓx²+A_{yy}y²+A_{xy}xy

f_{y}(x,y)=B₀+Bₓx+B_{y}y+Bₓₓx²+B_{yy}y²+B_{xy}xy (2)

where A₀, Aₓ, A_{y}, Aₓₓ, A_{yy}, A_{xy}, B₀, Bₓ, B_{y}, Bₓₓ, B_{yy}, and B_{xy} are fitting parameters determined by comparing the positions of the features (i.e., image content) in the first plane image data 100 to the positions of the corresponding features in the captured first plane image 125. The fitting parameters can be determined using any appropriate method known in the art. Functions of this type can be used to represent a wide variety of common image distortions including cross-track and in-track displacements and cross-track and in-track magnifications, as well as other more complex distortions such as skew and keystoning.

In an exemplary embodiment, the first plane image data 100 and the captured first plane image 125 are analyzed to determine a set of displacement vectors (sometimes called “motion vectors”) between corresponding features in the two images. The displacement vectors point from the expected location of the features in the first plane image data 100 to the corresponding position of the feature in the captured first plane image 125, thereby providing an indication of the displacement of the features. In some embodiments, the “images” that are analyzed can be the first plane image data 100 and the captured first plane image 125 for an entire page of the printed document. In other embodiments, a strip of image data corresponding to a subset of the page can be analyzed (e.g., a one inch tall strip across the width of the page).

Methods for determining displacement vectors are well-known in the image processing art. Typically, such methods involve using a feature matching algorithm to determine a set of corresponding features in a pair of images. The determined displacement vectors indicate the displacement (Δxᵢ, Δyᵢ) of the actual location of the i^{th} feature in the captured first plane image 125 relative to its intended location (xᵢ, yᵢ) in the first plane image data 100.

In some cases, the first plane image data 100 may include text characters. In such cases, text detection/recognition algorithms can be used to determine the locations of the text characters. The text characters can then be used as features. The locations of the corresponding text characters in the first plane image data 100 and the captured first plane image 125 can then be used to define the displacement vectors.

In some cases, the first plane image data 100 may include graphical elements or photographic images. In such cases, edge detection algorithms can be used to detect the edges of these elements. The detected edges can then be used as features. The locations of the corresponding edges in the first plane image data 100 and the captured first plane image 125 can then be used to define the displacement vectors. For example, the rectangular boundary around a photographic image can be identified in the first plane image data 100 and the captured first plane image 125, and the difference in the locations of the boundary can be used to define the displacement vectors.

In some cases, the outer boundaries of the image content on a printed page (or in a region of the printed page) can be used to define the displacement vectors. The locations of the first and last image lines containing printed image data, and the locations of the left-most and right-most pixels containing printed image data on a particular line can be compared to their expected locations to determine corresponding displacement vectors.

Once the displacement vectors are determined for a set of features distributed at different locations within the image, then a data fitting algorithm (such as the well-known least-squares fitting algorithm) can be used to determine the values of the fitting parameters that best fit the motion vector data.

A simpler set of parametric functions for representing the cross-track and in-track displacement functions uses a smaller number of parameters:

fₓ(x,y)=A₀+Aₓx

f_{y}(x,y)=B₀+B_{y}y (3)

In this case, the A₀ and B₀ parameters are essentially cross-track and in-track displacement parameter, respectively, and the Aₓ and B_{y} parameters are essentially cross-track and in-track magnification factor parameters. While these functions do not provide any means for characterizing higher order distortions of the receiver medium 14, they are able to account for the most common displacements, and furthermore the associated spatial adjustments 145 will be more amenable to performing at high processing speeds.

In an even simpler arrangement, the cross-track and in-track displacement functions include only cross-track and in-track displacement parameters:

fₓ(x,y)=A₀

f_{Y}(x,y)=B₀ (4)

In this case, the cross-track and in-track displacement parameters can be determined by simply computing the average values of the cross-track and in-track components of the determined displacement vectors.

In some embodiments, the cross-track and in-track displacement functions can be represented using 2D look-up tables (2D LUTS), which indicate the displacement (Δx, Δy) for a lattice of (x,y) image positions. The 2D LUTS would typically be represented at a lower spatial resolution than the first plane image data 100. For example, in some embodiments, the 2D LUTS can specify displacements for a set of different cross-track intervals corresponding to segments of the printhead 12, and for a set of different in-track intervals. For example, displacements can be specified independently for a set of 40 cross-track intervals across the width of printhead 12, and for a set of 25 in-track intervals down the length of a page. In this example, the displacement function can be represented in a 2D LUT with 40×25 elements. The 2D LUT approach is the most flexible for accounting for more complex image distortions such as skew, keystoning or localized expansion/shrinkage of the receiver medium 14. However, it will require more storage memory and more processing power to apply the associated spatial adjustments, particularly for larger 2D LUT sizes.

There is no requirement that the cells of the 2D LUT be uniform in shape. For example, the LUT cells can be one pixel high in the in-track direction so that the displacement values can be specified independently on a line-by-line basis, while each image line can be sub-divided into segments that include hundreds of pixels. There is also no requirement that all of the cross-track intervals or all of the in-track intervals be of the same size. For example, the LUT cells can be larger in portions of the image where lower ink amounts are printed (e.g., along the margins of the page).

In some embodiment the 2D LUTS can store coefficients of an appropriate parametric displacement function in each LUT element. For example, each LUT element can store the A₀ and B₀ cross-track and in-track displacement parameters of Eq. (4) to define a displacement for each of the corresponding image regions. In some embodiments, a 2D interpolation process (e.g., bi-linear interpolation) can be used to determine a smooth displacement function by interpolating between the displacements stored in the 2D LUT. This has the advantage that it can eliminate any artifacts that could otherwise occur at boundaries between the LUT cells. Alternatively, each LUT element can store the coefficients for some other form of parametric displacement function (e.g., the A₀ and B₀ cross-track and in-track displacement parameters, and the Aₓ and B_{y} cross-track and in-track magnification factor parameters of Eq. (3)). In this case, the coefficients for each cell can be defined so as to satisfy the boundary condition that the displacements at the cell boundaries should be equal to within one quantization level (e.g., to within one pixel).

A determine spatial adjustments step 140 determines a set of spatial adjustments 145 appropriate to account for the determined image displacement 135. The goal is to distort the second plane image data 105 in the same way that the printed first plane image 115 was distorted so that the printed images will coincide with each other. The spatial adjustments 145 can take a variety of different forms depending on the nature of the image displacement 135, as well as the adjustment means that are available. For example, for the case where the image displacement 135 includes a cross-track and in-track displacement parameters, the spatial adjustments 145 can include corresponding cross-track and in-track shift values. Similarly, if the image displacement 135 includes cross-track and in-track magnification factor parameters, the spatial adjustments 145 can include corresponding cross-track and in-track resize factors, and if the image displacement 135 includes a skew angle parameter the spatial adjustments 145 can include a rotation angle shift. For cases where the image displacement 135 includes a more complex functional form as described above, the spatial adjustments 145 can include similar functions which compensate for the associated image distortions. In this case, a magnitude of the shifting, resizing and rotation (e.g., for skew correction) that is done to compensate for the determined image displacement 135 will generally vary as a function of location within the second plane image data 105.

An adjust second image plane step 150 is then used to apply the spatial adjustments 145 to the second plane image data 105 to determine adjusted second plane image data 155. The adjust second image plane step 150 can apply the spatial adjustments 145 in a variety of different ways depending on the nature of the spatial adjustments 145, as well as the adjustment means that are available. In some cases, some or all of the adjustments can be applied within the printhead 12 (FIG. 1). In other cases, some or all of the adjustments can be applied by the controller 15 (FIG. 1), or using some other data processor. In some cases, the adjust second image plane step 150 can process the second plane image data 105 to determine a modified image which can then be printed using the normal printing process. In other cases, the adjust second image plane step 150 can adjust various printing parameters to apply some or all of the spatial adjustments.

In some embodiments, if the spatial adjustments 145 include a cross-track shift value, the adjust second image plane step 150 can apply the shift value by simply laterally shifting each line of the image data relative to the array of nozzles in the printhead 12 (FIG. 2) by a corresponding offset.

Similarly, if the spatial adjustments 145 include an in-track shift value, the adjust second image plane step 150 can apply the shift value by retarding or advancing the time at which each line of image data is printed to adjust its in-track position on the receiver medium 14. For example, to shift the second plane image data forward in the in-track direction by a certain distance Δy, each line can be printed earlier by a corresponding time interval Δt=Δy/V, where V is the web velocity.

If the spatial adjustments 145 include a cross-track resize factor (e.g., the Aₓ parameter of Eq. (3)), the adjust second image plane step 150 can resize the image data by inserting or deleting pixels along the line of image data. For example, to increase the cross-track size of the image by 1% in a particular image region, one pixel of image data can be inserted for every 100 pixels in the line of image data. Similarly, to reduce the cross-track size of the image by 1% in a particular image region, one pixel of image data can be deleted for every 100 pixels in the line of image data. Since adjustments of the cross-track magnification can only be made by inserting or deleting pixels, the adjustments will be quantized to the size of a pixel. In order to avoid visible artifacts, the insertion of deletion of pixels has to be done with care, particularly in the case where the image data being adjusted has already been halftoned to a binary representation. In some embodiments, the spatial adjustments 145 for the cross-track shift value and the cross-track resize value can be done using the method described in commonly-assigned, co-pending U.S. patent application Ser. No. 13/599,067 to Enge et al., entitled “Aligning print data using matching pixel patterns,” which is incorporated herein by reference. This approach reduces image artifacts by inserting or deleting the image pixels based on predefined pixel patterns.

In some embodiments, if the spatial adjustments 145 include an in-track resize factor (e.g., the Bₓ parameter of Eq. (3)), the adjust second image plane step 150 can resize the image data by adjusting the timing at which the lines of image data are printed. For example, to increase the in-track size of the image by a certain percentage, the time interval between when consecutive image lines are printed can be increased by the same percentage. This can be done by adjusting a frequency generator associated with the printhead 12 which controls the firing frequency for the nozzles in the printhead 12. In some embodiments, the firing frequency can be adjusted by over-clocking the master timing signal 19 (e.g., by a factor of 40×), then adjusting the number of over-clocked pulses that are counted between the printing of consecutive image lines. In some embodiments, each time a line is printed, a firing counter is loaded with a delay value indicating the time delay until the next line is printed. The value of the firing counter can be changed according to in-track magnification value calculated in the displacement. For the case where the master timing signal 19 is over-clocked by a factor of 40×, a firing counter of 40 would deliver nominal in-track magnification of the printed image. Values smaller or larger than 40 would deliver smaller or larger in in-track magnifications. In some embodiments, separate firing counters can be provided for individual segments of the printhead to provide independent control of the resize factor. In order to achieve a smooth in-track magnification correction without visible image artifacts, the adjustment of the time intervals should generally be quasi-continuous. Similarly, since corrections for distortions such as skew and keystone can also be made by adjustment of the time intervals between lines, over-clocking the master timing signal 19 by a large factor (e.g., 40×) achieves a quasi-continuous adjustment of the time intervals between lines.

Commonly-assigned U.S. Pat. No. 6,817,295 to Metzler, entitled “Method and illustration device for register mark setting” describes a method for adjusting a firing counter to control the image size that can be used in accordance with the present invention. In the described embodiment, the size control of the image is used to compensate for runout of rotating image-forming members, however it will be obvious to one skilled in the art that the same method can be used to compensate for image magnification distortions that originate from other sources as well. A series of related disclosures (U.S. Pat. No. 6,836,635 to Metzler et al., entitled “Method and control device for preventing register errors,” U.S. Pat. No. 6,848,361 to Metzler, entitled “Control device and method to prevent register errors,” and U.S. Pat. No. 6,920,292 to Metzler, entitled “Method and control device for prevention of image plane registration errors”) describe additional details of how this approach can be used compensate for other mechanical effects, and how a closed-loop control process can be implemented.

For embodiments where the spatial adjustments 145 are limited to a cross-track displacement parameter, an in-track displacement parameter, a cross-track magnification factor parameter, an in-track magnification factor parameter, the adjustments can readily be applied to the second plane image data 105 using data processors and frequency generators associated with the printhead 12 as has been described above. These adjustments can be applied even in the case where the second plane image data 105 has been halftoned to two levels (or multitoned to a small number of levels).

For cases where the spatial adjustments 145 include a rotation angle shift (to adjust the skew angle) or a more complex spatial adjustment function, the amount of adjustment will generally need to vary as a function of location within the image. For example, to correct for skew the amount of in-track displacement needs to vary across the width of the printhead 12. In some embodiments, this can be accomplished by applying different adjustments for different segments of the printhead 12. For example, in some embodiments the printhead 12 can be segmented into a number cross-track intervals (e.g., 40 segments). By providing separate in-track shift values, cross-track shift values, cross-track magnification values, and in-track magnification values (e.g., firing counters), for each segment of the printhead 12, complex spatial adjustments 145 can be applied to the image. In some embodiments, the number of separately controllable printhead segments can be equal to the number of cross-track elements in a 2D LUT used to represent the image displacement 135. The control values for each segment can be updated at intervals corresponding to the number of in-track elements in the 2D LUT.

For cases where complex spatial adjustments 145 are applied, it will sometimes be more convenient to process the second plane image data 105 to apply the desired corrections to determine a modified image which can then be printed using the normal printing process (i.e., without adjusting firing counters or other printhead control parameters). For example, the second plane image data 105 can be resampled using a grid of sample points whose positions have been shifted according to the spatial adjustments 145. It is preferable to perform the resampling operations on the image data before it's halftoned (or multitoned) to reduce the susceptibility to forming sampling artifacts. However, this may not be practical in all systems depending on the workflow and the processing capabilities of the data processors associated with the printing system 10.

A print second plane step 160 then prints the adjusted second plane image data 155 using the second printing module 20 by depositing an associated marking material on the receiver medium 14 (FIG. 1), thereby producing a printed second plane image 165, which is aligned with the printed first plane image 115. In accordance with the present invention, the adjustment of the second plane image data 105 provides reduced alignment errors between the printed first plane image 115 and the printed second plane image 165. The printed second plane image 165 can be printed on the same side of the receiver medium 14 as the printed first plane image 115 so that it overlays the printed first plane image 115. Alternately, it can be printed on the opposite side of the receiver medium 14 to provide a double-sided printed image.

As will be well-known to those skilled in the control systems art, it will sometimes be desirable to determine the spatial adjustments 145 for a particular image based on a plurality of captured first plane images 125. For example, when a sequence of identical (or similar) images are printed, it may be desirable to perform a moving average of the spatial adjustments 145 determined from each of the individual images in order to reduce noise in the determined spatial adjustments.

Optionally, the determined image displacement 135 can also be used to adjust the first plane image data 100 for subsequently printed images. In this case, information related to the image displacement 135 determined in the second printing module 20 of FIG. 1, is fed back to the first printing module 20 (as indicated by the spatial adjustment control signals 27 shown using dashed lines), where it is used to adjust the first plane image data 100. In this way, the subsequent image will have a reduced displacement between the nominal location of the printed image data the actual location of the printed image data. The first plane image data 100 can be adjusted in a similar fashion as was described relative to the adjust second image plane step 150 discussed above, except that the applied spatial adjustments 145 are determined to be in an opposite direction to the determined image displacement 135 to counteract the distortion.

The process discussed relative to FIG. 2 can be repeated for each of the subsequent image planes by using the image capture system 13 in the associated printing module 20 to capture an image of the previously printed image planes. The captured image can then be compared to the corresponding image data for the previously printed image planes to determine the appropriate spatial adjustments 145 for the current image plane. In some embodiments, the image printed by the first printing module is used as the reference for each of the subsequent image planes. In this case, the image data for that image plane is used for the first plane image data 100, and the captured image can be analyzed to detect the printed first plane image 115 (for example, by detecting the image content having the color associated with the first printing module 20). The image displacement 135 can then be determined relative to the first plane image data 100. In other embodiments, all of the previously printed image planes can be analyzed to determine an average image displacement 135. In this case, the captured image can be analyzed to detect each of image planes.

In some embodiments, if the analysis of the images captured by the image capture system 13 in the third printing module 20 shows that the printed second plane image 165 is not perfectly aligned with the printed first plane image 115, then appropriate spatial adjustment control signals 27 can be fed back to the second printing module 20 and used to apply spatial adjustments to the second plane image data 105 for subsequent images. The residual alignment errors can result from additional distortions in the receiver medium 14 that occur between the image capture system 13 and the printhead 12 in the second printing module 20, or can result from inaccuracies in the determination of the image displacement 135 (e.g., due to misalignment of the image capture system 13). The spatial adjustment control signals 27 can be provided by determining an image displacement between the printed first plane image 115 and the printed second plane image 165 in the image captured by the image capture system 13 in the third printing module 20. In some embodiments, the spatial adjustment control signals 27 can be a representation of the residual displacement, which can be combined with the image displacement 135 determined using the method of FIG. 2 and then used to determine appropriate spatial adjustments 145. This can further reduce registration errors so as to more accurately align the printed second plane image 165 of the subsequent image with respect to the printed first plane image 115. Obviously, this principle can be extended for all of the following printing modules.

The present invention provides the advantage that the alignment characteristics of the printed images is evaluated in real-time, and used to provide rapid correction of any misalignment that is detected. This is important for printing systems 10 that are used to print variable image content where the amount and distribution of marking material (e.g., ink), and therefore the amount of distortion that is introduced to the receiver medium 14, can vary on a page-by-page basis. Since the misalignment of the first image plane is determined before the second image plane is printed, the distortions of the receiver medium 14 associated with the particular image content can be accurately accounted for when the second image plane is printed.

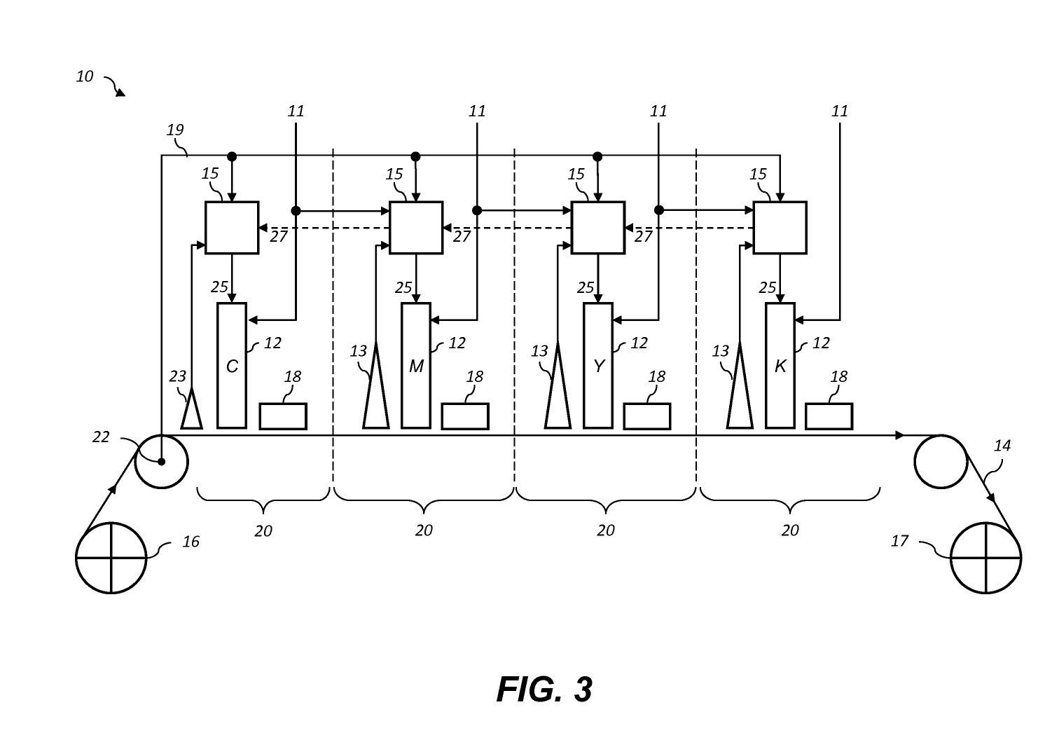

In some embodiments, a registration feature sensor 23 can be positioned along the transport path upstream of the printhead 12 in the first printing module 20 as shown in FIG. 3. The registration feature sensor 23 is adapted to detect a location of one or more registration features on the receiver medium 14. The registration features may be preformed on the receiver medium 14 at a prior time (e.g., during the manufacturing of the receiver medium 14). Alternately, they may be printed or applied to the receiver medium 14 using some upstream system (not shown in FIG. 3). The registration features allow the position of the receiver medium to be accurately determined as the receiver medium 14 travels along the transport path.

The registration features can be any detectable markings that can be readily detected using an appropriate sensing means. Examples of registration features would be printed marks (visible of UV-fluorescent), holes formed through the media or embedded security bands. In some embodiments, the edge of the receiver medium 14 can be used as a registration feature. In other embodiments, a perforation of the receiver medium 14, or preprinted image content (e.g., pre-printed forms) can also be used as registration features. In some embodiments, the registration features can be formed using the method described in commonly-assigned, co-pending U.S. patent application Ser. No. 13/941,713 to Piatt et al., entitled “Media-tracking system using marking heat source,” which is incorporated herein by reference. This approach utilizes a small heat source which forms periodic marks on the receiver medium 14 by discoloring the receiver medium 14, altering a fluorescence of the receiver medium 14, or burning a hole through the receiver medium 14.

Typically, the registration features are formed at periodic intervals along one or both edges of the receiver medium 14. The registration features can be a series of small spots, or alternately can be reticules, or other geometric features.

In some embodiments, the registration feature sensor 23 can be a digital imaging system similar to (or even identical to) the image capture systems 13. Alternately, the registration feature sensor 23 can be any type of sensing system known in the art appropriate for detecting the position of registration features. For example, the registration feature sensor 23 can be a point sensor that detects when the registration feature passes by, or it can be an edge sensor that senses a location of a media edge. In some cases a plurality of registration feature sensors 23 can be used. For example, one the registration feature sensor 23 can be positioned to detect registration features along the left edge of the receiver medium 14, and a second registration feature sensor 23 can be positioned to detect registration features along the right edge of the receiver medium 14.

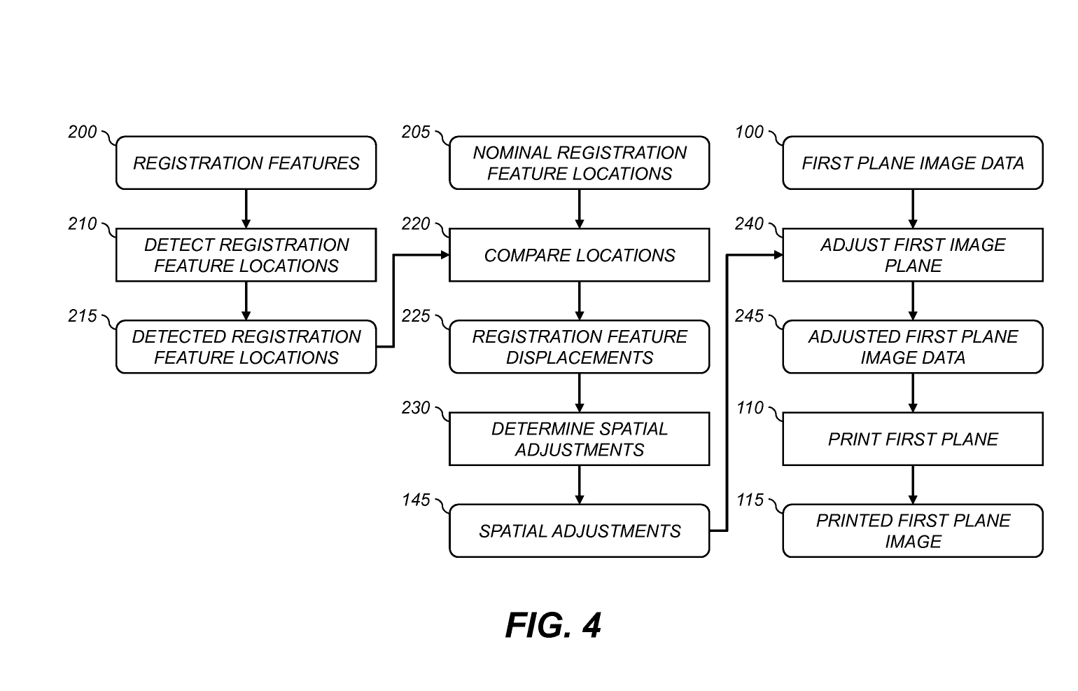

FIG. 4 shows a flowchart of a method for controlling the printing system 10 (FIG. 3) for a receiver medium 14 (FIG. 3) having a set of registration features 200 with corresponding nominal registration feature locations 205. A detect registration feature locations step 210 uses the registration feature sensor 23 (FIG. 3) to detect one or more of the registration features 200 and determine corresponding detected registration feature locations 215.

A compare locations step 220 compares the detected registration feature locations 215 to the corresponding nominal registration feature locations 205 to determine registration feature displacements 225. For example, the nominal registration feature locations 205 may indicate that the registration features are expected to be found at predefined in-track intervals along both edges of the receiver medium 14 at particular cross-track positions. If the registration feature displacements 225 are found to be non-zero, then this provides an indication that the receiver medium 14 has been displaced relative to its expected location (e.g., due to some or all of cross-track shift, in-track shift, in-track expansion/shrinkage or cross-track expansion/shrinkage). For example, if the registration features are all shifted to the right or the left in the cross-track direction this would indicate that a cross-track shift had occurred. Similarly, if the registration features are all shifted forward or backward in the in-track direction this would indicate that an in-track shift had occurred. If the registration features along the opposite edges of the receiver medium 14 are closer or farther apart than an expected distance this would indicate that a cross-track expansion/shrinkage had occurred. Similarly, if the periodic registration features along one of the edges are farther apart than an expected period this would indicate that an in-track expansion/shrinkage had occurred.

A determine spatial adjustments step 230 analyzes the registration feature displacements 225 to determine appropriate spatial adjustments 145 that can be applied to the first plane image data 100 in order to position the first image plane in a predefined location relative to the registration features 200.

As with the spatial adjustments 145 of FIG. 2, the spatial adjustments 145 can take a variety of different forms depending on the nature of the registration feature displacements 225, as well as the adjustment means that are available. For example, for the case where the registration feature displacements 225 indicate that the receiver medium 14 has undergone cross-track and in-track displacements, the spatial adjustments 145 can include corresponding cross-track and in-track shift values. Similarly, if the registration feature displacements 225 indicate that the receiver medium 14 has undergone cross-track and in-track expansion/shrinkage, the spatial adjustments 145 can include corresponding cross-track and in-track resize factors, and if the registration feature displacements 225 indicate that the receiver medium 14 is skewed the spatial adjustments 145 can include a rotation angle shift. In some cases, the spatial adjustments 145 can also include more complex adjustment functions as has been described above relative to the spatial adjustments 145. (Although it would generally be necessary to have a registration features 200 located at other locations besides along the edges of the receiver medium 14 in order to determine that such complex adjustment functions are appropriate.

An adjust first image plane step 240 is then used to adjust the first plane image data 100 responsive to the determined spatial adjustments 145 to determine an adjusted first plane image data 245. The details of this step will be analogous to those that were discussed earlier with respect to the adjust second image plane step 150 (FIG. 2).

Finally, print first plane step 110 is used to print the adjusted first plane image data 245 using the first printing module 20 (FIG. 3) by depositing an associated marking material on the receiver medium 14 (FIG. 3), thereby producing printed first plane image 115. In accordance with the present invention, the image content in the printed first plane image 115 will be positioned more accurately relative to the registration features than if the first plane image data 100 had been printed without any adjustments.

An analogous process can be used for each of the subsequent image planes. In this case, the image capture systems 13 (FIG. 3) can be used to serve the function of the registration feature sensor 23 (FIG. 3). The image capture systems 13 can capture an image of the receiver medium 14 which includes the registration features 200 as well as the previously printed image planes. The captured image can then be analyzed to determine the detected registration feature locations 215. In this case, the spatial adjustments 145 can be determined responsive to both the determined registration feature displacements 225, as well as the image displacement 135 (FIG. 2).

In some embodiments, if the analysis of the images captured by the image capture system 13 in the second printing module 20 shows that the printed first plane image 115 is not perfectly positioned at the desired predefined location relative to the registration features 200, then appropriate spatial adjustment control signals 27 can be fed back to the first printing module and used to apply spatial adjustments to the first plane image data 100 for subsequent images. The residual alignment errors can result from additional distortions in the receiver medium 14 that occur between the registration feature sensor 23 and the printhead 12 in the first printing module 20, or can result from inaccuracies in the determination of the registration feature displacement 225 (e.g., due to misalignment of the registration feature sensor 23). In some embodiments, the spatial adjustment control signals 27 can be representation of a residual error in the location of the printed first plane image 115 with respect to the locations of the registration features in the captured image, which can be combined with the registration features displacements 225 determined using the method of FIG. 4 and then used to determine appropriate spatial adjustments 145. This can further reduce registration errors so as to more accurately position the printed first plane image 115 in subsequent images at the desired predefined location relative to the registration features 200.

The embodiments that have been discussed above have focused primarily on a “feed-forward” approach where spatial adjustments 145 (FIG. 2) that are determined for the second printing module 20 (FIG. 3) are determined by analyzing the captured first plane image 124 (FIG. 2), which is captured using the image capture system 13 (FIG. 3) positioned between the printheads 12 (FIG. 3) in the first and second printing modules 20. In such embodiments, it is generally desirable to position the image capture system 13 as close as possible to the printhead 12 in the second printing module 20. This will minimize the effects of any residual distortions of the receiver medium 14 that may occur as it travels along the transport path between the image capture system 13 and the printhead 12 in the second printing module 20.

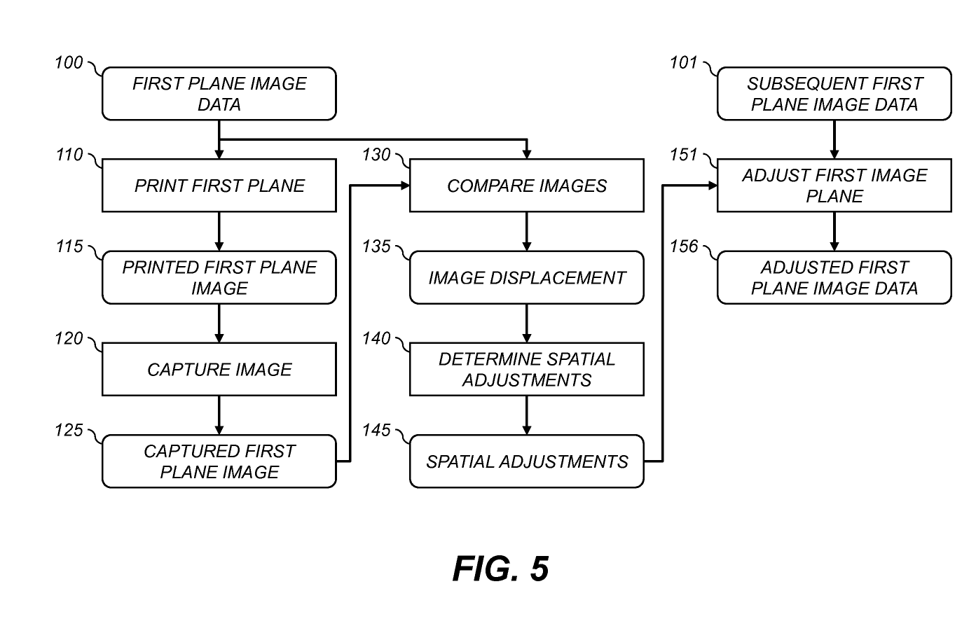

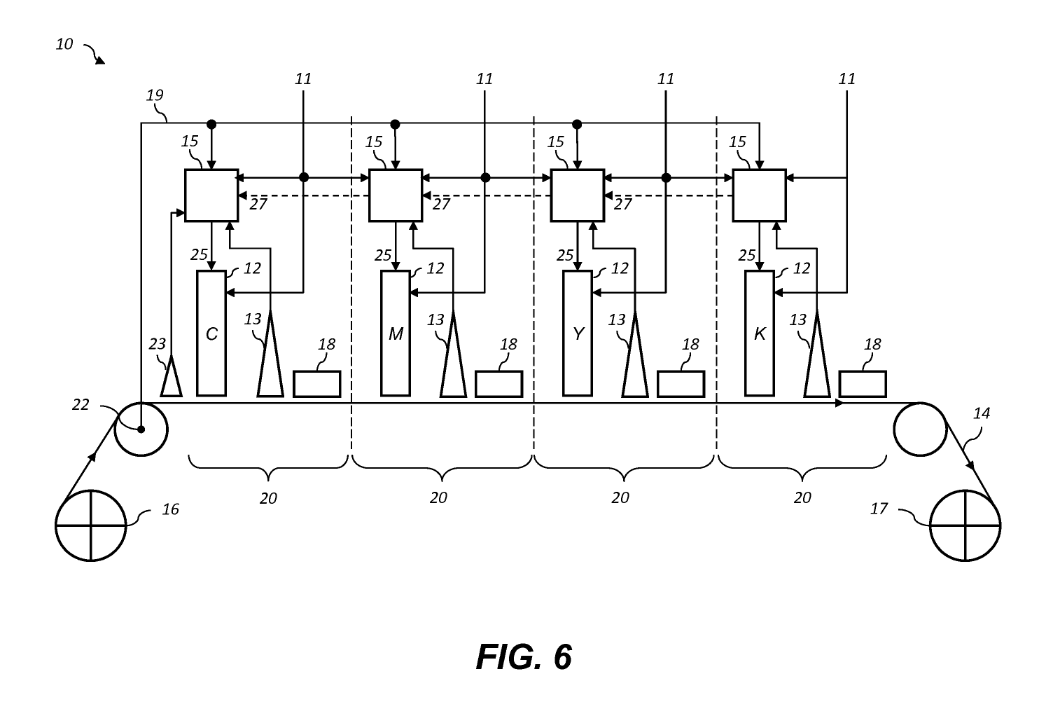

FIG. 5 shows a flowchart for a “feedback” configuration that can be used according to an alternate embodiment. With this approach, the image displacement (i.e., the misalignment) of a particular image plane is evaluated by capturing an image of the printed image after the image plane has been printed. The image displacement is then used to correct the alignment of a subsequently printed image. In this case, it is generally desirable to position the image capture system 13 used to capture the image close to the printhead 12 that is being evaluated. For example, FIG. 6 shows an example of a printing system 10 where the image capture systems 13 in each printing module 20 are positioned just after the printhead 12 and before the dryer 18. Other aspects of the printing system 10 are analogous to FIG. 3.

According to the method shown in FIG. 5, the first plane image data 100 is printed and compared to a captured first plane image 125 to determine an image displacement 135 using the same steps that were described earlier with respect to FIG. 2. However, in this case, rather than determining spatial adjustments 145 appropriate for use in adjusting the second plane image data 105 (FIG. 2), spatial adjustments 145 are determined that are used to adjust a subsequent image. In the illustrated embodiment, an adjust first image plane step 151 is used to adjust subsequent first plane image data 101 to provide adjusted first plane image data 156. In this way, when the adjusted first plane image data 156 is printed it will have reduced alignment errors relative to its nominal location.

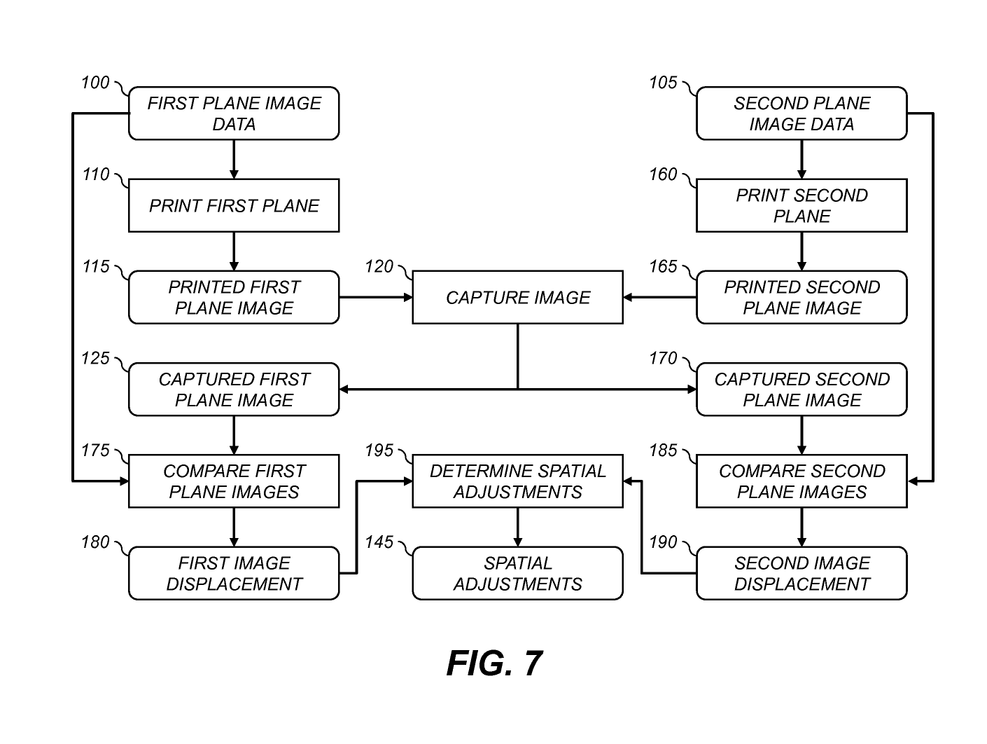

Another feedback approach is illustrated in FIG. 7 where the spatial adjustments 145 used to adjust the alignment of the first and second printing modules 20 are determined based on evaluating both printed image planes. In this case, the image capture system 13 that is used to evaluate the alignment of the first and second printing modules 20 is positioned after the printhead 12 in the second printing module 20. One advantage of this approach is that the position of the image capture system 13 is less critical than for the feed-forward configurations.

According to the method of FIG. 7, the print first plane step 110 is used to print the first plane image data 100 using the printhead 12 (FIG. 6) in the first printing module 20 (FIG. 6) to provide printed first plane image 115. Likewise, print second plane step 160 is used to print the second plane image data 105 using the printhead 12 in the second printing module 20 to provide printed second plane image 165.

The image capture system 13 (FIG. 6) in the second printing module 20 (which is downstream of the printhead 12 in the second printing module 20) is then used to perform the capture image step 120. The resulting image will include information about both the printed first plane image 115 and the printed second plane image 165. In a preferred embodiment, the image capture system 13 uses a color image sensor that provides color image data that can be analyzed to separate the different color channels. For example, a red color channel of the color image data can be used to provide information about a cyan color plane, a green color channel of the color image data can be used to provide information about a magenta image plane, and a blue color channel of the color image data can be used to provide information about a yellow image plane. In this way, the captured image can be processed to provide a captured first plane image 125 providing a representation of the printed first plane image 115 and a captured second plane image 170 providing a representation of the printed second plane image 165. In some cases, color processing can be used to eliminate (or reduce) cross-talk between the different image planes and the color channels in the captured image.

A compare first plane images step 175 is used to compare the first plane image data 100 to the captured first plane image 125 to determine a first image displacement 180. Likewise, a compare second plane images step 185 is used to compare the second plane image data 105 to the captured second plane image 170 to determine a second image displacement 190. (The compare first plane images step 175 and the compare second plane images step 185 function in an analogous manner to the compare images step 130 that was discussed earlier with respect to FIG. 2.)

A determine spatial adjustments step 195 is then used to determine spatial adjustments 145 responsive to the first image displacement 180 and the second image displacement 190. The spatial adjustments 145 are appropriate to be applied to at least one of the first and second image planes of a subsequent image so as to provide reduced alignment errors between the printed image data for the first and second image planes in the subsequent image.

The determine spatial adjustments step 195 can determine the spatial adjustments 145 in various ways according to different embodiments. In an exemplary embodiment, the first image displacement 180 is compared to the second image displacement 190 to determine a relative displacement between the printed first plane image 115 and the printed second plane image 165. (For example, if Δx₁ is a cross-track displacement for a particular pixel in the first plane image data 100 and Δx₂ is a cross-track displacement for the corresponding pixel in the second plane image data 105, then the cross-track component of the relative displacement can be determined as Δxᵣ=Δx₂−Δx₁.) The determined relative displacement can then be used to determine spatial adjustments that can be used to adjust the second plane image data 105 for the subsequent image so that the printed second plane image 165 of the subsequent image will have substantially the same displacement as the printed first plane image 115 of the subsequent image. (For example, the spatial adjustments 145 applied to the second plane image data 105 can be specified to be equal in magnitude and opposite in direction relative to the determined relative displacement.) In this way, the alignment errors between the printed first plane image 115 and the printed second plane image 165 will be reduced for the subsequent image. In some embodiments, the relative displacement can be determined directly by analyzing the captured first plane image 125 and the captured second plane image 170, rather than by explicitly determining the first image displacement 180 and the second image displacement 190.

In other embodiments, spatial adjustments 145 can be determined for adjusting both the first plane image data 100 and the second plane image data 105. For example, the first image displacement 180 can be used to determine spatial adjustments for the first plane image data 100 and the second image displacement 190 can be used to determine spatial adjustments for the second plane image data 105. In this way, the printed first plane image 115 and the printed second plane image 165 for the subsequent image will both have reduced alignment errors relative to their nominal locations.

The invention has been described in detail with particular reference to certain preferred embodiments thereof, but it will be understood that variations and modifications can be effected within the spirit and scope of the invention.

### PARTS LIST

10 printing system
11 image data
12 printhead
13 image capture system
14 receiver medium
15 controller
16 supply roll
17 take-up roll
18 dryer
19 master timing signal
20 printing module
22 encoder
23 registration sensor
25 spatial adjustment control signals
27 spatial adjustment control signals
100 first plane image data
101 subsequent first plane image data
105 second plane image data
110 print first plane step
115 printed first plane image
120 capture image step
125 captured first plane image
130 compare images step
135 image displacement
140 determine spatial adjustments step
145 spatial adjustments
150 adjust second image plane step
151 adjust first image plane step
155 adjusted second plane image data
156 adjusted first plane image data
160 print second plane step
165 printed second plane image
170 captured second plane image
175 compare first plane images step
180 first image displacement
185 compare second plane images step
190 second image displacement
195 determine spatial adjustments step
200 registration features
205 nominal registration feature locations
210 detect registration feature locations step
215 detected registration feature locations
220 compare locations step
225 registration feature displacements
230 determine spatial adjustments step
240 adjust first image plane step
245 adjusted first plane image data

1. A printer for printing an image on a receiver medium moving along a transport path, comprising:
a first marking unit for printing image data for a first image plane by depositing a first marking material on the receiver medium as the receiver medium is transported along the transport path past the first marking unit;
a second marking unit for printing image data for a second image plane by depositing a second marking material on the receiver medium as the receiver medium is transported along the transport path past the second marking unit, the second marking unit being positioned along the transport path downstream of the first marking unit;
a digital image capture system positioned along the transport path downstream of the second marking unit, the digital image capture system being adapted to capture an image of the printed first and second image planes; and
a control system that implements an image alignment method, wherein the image alignment method includes:
receiving image data for the first and second image planes;
controlling the first marking unit to print the image data for the first image plane by depositing a corresponding pattern of the first marking material on the receiver medium;
controlling the second marking unit to print the image data for the second image plane by depositing a corresponding pattern of the second marking material on the receiver medium;
controlling the digital image capture system to capture an image of the printed first and second image planes;
comparing the image data for the first image plane to the captured image of the printed first image plane to determine a first displacement between a nominal location of the printed image data for the first image plane and an actual location of the printed image data for the first image plane;
comparing the image data for the second image plane to the captured image of the printed second image plane to determine a second displacement between a nominal location of the printed image data for the second image plane and an actual location of the printed image data for the second image plane; and
determining spatial adjustments in accordance with the determined first and second displacements; and
applying the spatial adjustments to image data for at least one of the first and second image planes of a subsequent image in accordance with the determined first and second displacements;
wherein the spatial adjustment of the image data for the at least one of the first and second image planes of the subsequent image is adapted to provide reduced alignment errors between the printed image data for the first and second image planes in the subsequent image.

2. The printer of claim 1 wherein the determination of the spatial adjustments are includes:
comparing the first displacement to the second displacement to determine a relative displacement between the printed image data for the first and second image planes; and
determining the spatial adjustments in accordance with the determined relative displacement.

3. The printer of claim 1 wherein the spatial adjustments are applied to the image data for the second image plane of the subsequent image such that the printed image data for the second image plane of the subsequent image will have substantially the same displacement as the printed image data for the first image plane of the subsequent image.

4. The printer of claim 1 wherein the spatial adjustments are applied to the image data for both the first and second image planes of the subsequent image such that the printed image data for the first and second image planes of the subsequent image will have reduced alignment errors relative to the nominal locations of the printed image data for the first and second image planes.

5. The printer of claim 1 wherein the determination of the first or second displacement includes:
analyzing the image data for the respective image plane and the captured image of the respective printed image plane to determine a set of actual feature locations in the captured image of the respective printed image plane corresponding to a set of intended feature locations in the image data for the respective image plane; and
determining the displacement responsive to differences between the actual feature locations and the corresponding intended features locations.

6. The printer of claim 5 wherein the determination of the first or second displacement includes:
defining a plurality of displacement vectors representing the differences between the actual feature locations and the corresponding intended features locations; and
fitting a parametric displacement function to the plurality of displacement vectors, wherein the displacement function relates locations in the image data for the respective image plane to corresponding displaced locations in the captured image of the respective printed image plane.

7. The printer of claim 1 wherein the determined first or second displacement varies as a function of location within the respective image plane.

8. The printer of claim 7 wherein the determined first or second displacement is specified using a parametric displacement function.

9. The printer of claim 7 wherein the determined first or second displacement is specified using a two-dimensional look-up table which stores displacement values for a set of series of cross-track intervals and a series of different in-track intervals.

10. The printer of claim 1 wherein the adjustment of the image data includes shifting or resizing at least a portion the image data in at least one dimension.

11. The printer of claim 10 wherein a magnitude of the shifting or resizing varies as a function of location within the respective image plane.

12. The printer of claim 1 wherein the adjustment of the image data includes adjusting a timing at which lines of the adjusted image data are printed.

13. The printer of claim 1 wherein the adjustment of the image data includes adjusting a skew angle for at least some of the image data.

14. The printer of claim 1 wherein the second image plane is printed on an opposite side of the receiver medium from the first image plane.

15. The printer of claim 1 wherein the image data for the first image plane includes text, graphics or a photographic image content that are part of the printed image and does not include registration marks.

16. The printer of claim 1 further including:
a registration feature sensor positioned along the transport path upstream of the first marking unit, the registration feature sensor adapted to detect a location of one or more registration features on the receiver medium;
wherein the image alignment method implemented by the control system further includes:
detecting location of the one or more registration features using the registration feature sensor;
comparing the detected location of the one or more registration features to a nominal location of the one or more registration features to determine one or more registration feature displacements; and
applying spatial adjustments to the image data for the first image plane in accordance with the one or more determined registration feature displacements;
wherein the adjustment of the image data for the first image plane is adapted to position the first image plane in a predefined location relative to the registration features.

17. The printer of claim 1 wherein the receiver medium includes one or more registration features and the image alignment method implemented by the control system further includes:
determining a location of the one or more registration features in the captured image of the printed first and second image planes;
determining a relative location of the printed image data for the first image plane with respect to the determined locations of the one or more registration features; and
applying spatial adjustments to image data for the first image plane of a subsequent image in accordance with the determined relative location, wherein the adjustment of the image data for the first image plane is adapted to position the first image plane of the subsequent image in a predefined location relative to the one or more registration features.
